(19) United States
(12) Patent Application Publication
(10) Pub. No.: US 2024/0388050 A1
(43) Pub. Date: Nov. 21, 2024

(54) TRANSPORT UNIT

(71) Applicant: ZOLLER & FRÖHLICH GMBH, Wangen im Allgäu (DE)

(72) Inventors: Christoph Fröhlich, Wangen (DE); Steffen HARTINGER, Wangen (DE); Armin FISCHER, Wangen (DE); Bernhard GRAF, Wangen (DE)

(73) Assignee: ZOLLER & FRÖHLICH GMBH, Wangen im Allgäu (DE)

(21) Appl. No.: 18/688,755

(22) PCT Filed: Sep. 2, 2022
(86) PCT No.: PCT/EP2022/074522

§ 371 Date: Mar. 2, 2024

(30) Foreign Application Priority Data
Sep. 6, 2021 (DE) 10 2021 123 012.8

(51) Int. Cl. H01R 43/055; B23P 19/00

(52) U.S. Cl. CPC H01R 43/055; B23P 19/001

(57) ABSTRACT

A transport unit conveys a belt strip with wire ferrules into a crimping machine. The transport unit has a base body with a ferrule channel through which the belt strip can be moved incrementally by a transport nose. The transport nose is formed on a transport pawl. The transport slider is guided parallel to the ferrule channel and can be driven in an oscillating manner. The transport nose is forced between two respective wire ferrules by a force transverse to the advancing direction and to the ferrule channel. The belt strip can be supported by means of two holding noses in a retracting direction. The two holding noses are formed on holding pawls, the respective pivot bearings of which are fixed to the base body. The two holding noses are forced between two respective wire ferrules by a respective force transverse to the advancing direction and to the ferrule channel.

### CROSS REFERENCE TO RELATED APPLICATIONS

This application is a National Phase Application of and claims priority to International Application Number PCT/EP2022/074522, filed Sep. 2, 2022, which claims priority to German Application Number 10 2021 123 012.8, filed Sep. 6, 2021, the entire disclosures of each of which are incorporated herein by reference.

### BACKGROUND

The disclosure relates to a transport unit which is insertable into a crimping machine, and which serves to transport a belt strip with wire-end sleeves stepwise.

The printed publication DE 197 37 148 A1 shows such a transport unit. An oscillatingly driven transport slider has a transport pawl articulated to it, whose pivot bearing oscillates with the transport slider. A feed nose of the transport pawl is attached to the respective wire-ferrules so that these are individually pushed out of a channel of the transport unit. For this purpose, the feed nose has a contact area that is oriented perpendicular to the advancing direction, so that during an advancing movement the feed nose remains in contact with the wire ferrule and transports it safely in the advancing direction. The entire belt strip is entrained in the process. The other side of the feed nose is designed so that it slides off the adjacent wire ferrule during a return movement of the transport slider against the advancing direction and does not pull it back.

A transport unit for the same purpose is disclosed in the printed publication DE 197 14 964 C1. Apart from the transport pawl, whose pivot bearing oscillates with the transport slider, it also has a stop pawl that functions similarly in principle, whose nose (attachment) also dips between the individual wire ferrules. Unlike the transport pawl, the stop pawl is hinged to the base body of the transport unit. The nose of the stop pawl has a contact area which is oriented perpendicular to the advancing direction, and which remains in contact with the wire ferrule concerned during a retraction movement of the transport nose of the transport pawl and holds it securely. Here, the entire belt strip is held in place. The other side of the nose is designed in such a way that it slides away from the adjacent wire ferrule during an advancing movement of the transport nose and does not hold it back.

In the installation position shown in the Figures of DE 197 14 964 C1, the stop pawl is arranged above the wire ferrules. A long arm of the stop pawl extends from its pivot bearing to the wire ferrule to be held. The weight of this long arm is reinforced by a spring. This means that the transport unit is not suitable for an inverted installation position in which the stop pawl is to plunge between the wire ferrules from below, since in this case the long arm of the stop pawl reduces the force with which the nose plunges. In more general terms, the disadvantage of such transport units is that the function of the single stop pawl is dependent on the installation position of the transport unit.

### SUMMARY

On the other hand, the object of the disclosure is to create a transport unit whose holding function is improved in various installation positions.

This object is solved by a transport unit with the features of the independent claim.

Further advantageous embodiments of the disclosure are described in the dependent patent claims.

The claimed transport unit has a base body, in which a ferrule channel is formed through which a belt strip with wire ferrules is movable stepwise in an advancing direction via a transport nose. The transport nose is formed on a transport pawl, which is pivotably articulated to a transport slider via a pivot bearing. The transport slider is guided parallel to the ferrule channel and may preferably be driven in an oscillating manner via a coupling device (e.g., a pivot) and a main spring. The transport nose is pushed between two wire ferrules with a force transverse to the advancing direction and transverse to the ferrule channel. Furthermore, the belt strip may be supported in a retracting direction reverse to the advancing direction via a first holding nose. The first holding nose is formed on a first holding pawl, the first pivot bearing of which is fixed to the base body. The first holding nose is also pushed with a force transverse to the advancing direction and to the ferrule channel between two respective wire ferrules. According to the disclosure, the belt strip may also be supported in the retracting direction via a second holding nose, wherein the second holding nose is formed on a second holding pawl, the second pivot bearing of which is also fixed to the base body. The second holding nose is also pressed between two wire ferrules with a force transverse to the advancing direction and to the ferrule channel. With the transport unit according to the disclosure, the holding function is improved in various installation positions.

In the manner known per se from DE 197 14 964 C1, the holding noses of the holding pawls have a contact area which is oriented perpendicular to the advancing direction, and which remains in contact with the concerned wire ferrule during a retraction movement of the transport nose and holds it securely. The entire belt strip is held in this way. The respective other side of each of the two holding noses is designed in such a way that they slide off the adjacent wire ferrule during an advancing movement of the transport nose and do not hold it back.

With the transport unit according to the disclosure, the holding function is further improved in different installation positions if the two holding pawls are located opposite each other with respect to the ferrule channel.

In DE 197 14 964 C1, the pivot movement of the single stop pawl in the insertion direction is limited by an extension of the stop pawl, which is formed adjacent to the nose, and which is supported on the collar of the wire ferrule. This results in a dependence of the holding function of the stop pawl on the diameter of the collar of the wire ferrule. In contrast, according to the disclosure, it is preferred if a transition from the holding nose to the rest of the holding pawl is simply crescent-shaped in order to achieve independence of the holding function from the diameter of the collar of the wire ferrule. For this purpose, a stop fixed to the base body for limiting the pivot movement in the insertion direction is preferred for each holding pawl, against which a respective extension of the holding pawl can come into contact, which is formed with respect to the pivot bearing on a side of the holding pawl opposite the holding nose.

For a long service life and for reasons of precision, it is particularly preferable if the entire transport unit is made of metal.

The force of the holding noses and/or of the transport nose can be generated device-related simply by their own weight force or by the weight force of a weight portion of the respective pawl. The weight portion can be the dead weight of the pawl and/or nose.

Preferably, the transport unit according to the disclosure is installed in a crimping machine in an installation position in which the wire ferrules are moved horizontally through the ferrule channel.

If, in the preferred installation position of the transport unit, the nose concerned is to be pushed from below between two wire ferrules in each case, then the weight portion has to be formed with respect to the pivot bearing on an extension of the pawl opposite the nose. If, on the other hand, the nose is to be pushed from above between two wire ferrules in the preferred installation position of the transport unit, then in the case of the weight portion, this has to be formed with respect to the pivot bearing on the area of the pawl where the nose is also formed.

In order to ensure safe insertion of the pawls between the wire ferrules, independent of the preferred installation position, it is particularly preferable if at least part of the respective force is generated via a spring that acts on the respective pawl. In the case of the two holding pawls, this spring is supported on a spring system fixed to the base body; in the case of the transport pawl, the spring is supported on the transport slider. It is particularly preferable if all three pawls each have a respective spring that clamps the respective nose between the wire ferrules.

In a simple design of the transport unit in terms of device technology and assembly, the two holding pawls are identical. Alternatively, the holding pawls may also be designed with different dimensions, in particular different thicknesses, in order to adapt them to the available installation space.

In a specific configuration example, in the preferred installation position of the transport unit, the transport nose and the first holding nose are pushed from above between two wire ferrules in each case, while the second holding nose is pushed from below between two wire ferrules in each case.

In terms of maintenance, it is advantageous if, in the preferred installation position, a lid is attached to the outside of the base body, which extends along or parallel to the ferrule channel.

In terms of assembly, it is advantageous if the second pivot bearing of the second holding pawl is arranged in a bearing portion of the lid. The bearing portion may also form a wall portion of the ferrule channel on its upper side in the preferred installation position.

Preferably, the two holding pawls are arranged between the transport pawl and an outer surface of the lid.

At least one of the three pawls may have an extension, wherein the extension is opposite the nose with respect to the respective pivot bearing. A pin that is movable with the pivot movement of the pawl may be attached to the extension and extends outward through an outer surface of the lid. The movement of the affected pawl can be observed, and, in the event of a malfunction, the affected pawl can be moved manually without having to remove the lid. Preferably, all three pawls have such a pin.

As already mentioned, the pivot bearing of the transport pawl is arranged on the transport slider. Preferably, a recess (e.g., an indentation) for the extension and the spring of the transport pawl is formed in the transport slider. The coupling device (e.g., a pivot) is also attached to the transport slider and the main spring engages with it.

In order to be able to mount the two holding pawls opposite each other with respect to the ferrule channel, it is preferable if the lid-fixed bearing portion is also arranged substantially in the recess of the transport slider. The bearing portion with the second holding pawl mounted in it can then be positioned as close as possible to the transport pawl to save space when mounting the lid.

Preferably, a separation plate is formed or attached to the transport slider to keep the wire ferrules at the same level, e.g., height level.

For this purpose, the separation plate preferably has an extension directed in the advancing direction, which is oscillatingly moved out in the advancing direction and retracted again. A front side of a respective wire ferrule can be brought into contact with the extension transversely to the advancing direction when the wire ferrule is separated.

A passage recess (e.g., a slit) may be arranged in the separation plate between the extension and a main portion of the separation plate, into which a cutting knife is insertable for cutting off a wire ferrule from the belt strip.

The main portion of the separation plate may be arranged and/or guided at least sectionally in an indentation on an inner side of the lid. The indentation may comprise the bearing portion of the lid, wherein the bearing portion extends through a passage recess of the main portion of the separation plate. The pin of the transport pawl may also extend through the passage recess to the outer surface of the lid.

A spring-loaded flap on a foot of the ferrule channel ensures that the last wire ferrule of the belt strip does not jam in the ferrule channel.

### BRIEF DESCRIPTION OF DRAWINGS

A configuration example of the transport unit according to the disclosure is shown in the Figures.

The following is shown:

FIG. 1 shows a view of the configuration example of the transport unit according to the disclosure,

FIG. 2 shows another view of the transport unit from FIG. 1, with lid and separation plate omitted,

FIG. 3 shows the transport unit in the view from FIG. 2, with the lid and the separation plate again omitted,

FIG. 4 shows the transport unit in the view from FIGS. 2 and 3, with only the lid omitted,

FIG. 5 shows a perspective view of the transport unit from the previous Figures, with the lid omitted,

FIG. 6 shows a perspective view of the front part of the transport unit, with the lid and

the separation plate omitted,

FIG. 7 shows a perspective view of the transport unit, and

FIG. 8 shows the lid of the transport unit in a view from the inside.

### DESCRIPTION

The directions ‘up,’ ‘down,’ ‘inside,’ and ‘outside’ mentioned in the following figure description refer to a preferred installation position of the transport unit in a crimping machine. In this installation position, the transport unit is arranged in a side wall of the crimping machine, wherein the belt strip and the wire ferrule are guided horizontally in a ferrule channel of the transport unit. However, the transport unit may also be installed in all other installation positions in a crimping machine.

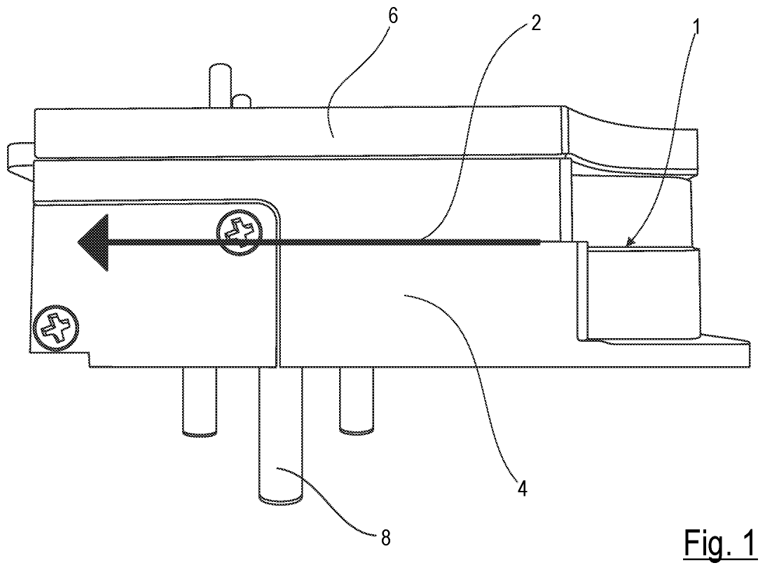

FIG. 1 shows a top view of the configuration example of the transport unit according to the disclosure. A belt strip with wire ferrule of size 0.5-2.5 qmm is inserted into a ferrule channel 1 of the transport unit. An advancing direction 2 of the belt strip is directed from right to left in FIG. 1.

The ferrule channel 1 is formed in a base body 4 and covered with a lid 6. On a side of the base body 4 opposite the lid 6, a pivot 8 protrudes from the base body 4. In the preferred installation position, the lid 6 is on the outside and the pivot 8 protrudes inward, toward the inside of the crimping machine, so that the pivot 8 can be driven in an oscillating manner and the lid 6 can be removed from the outside.

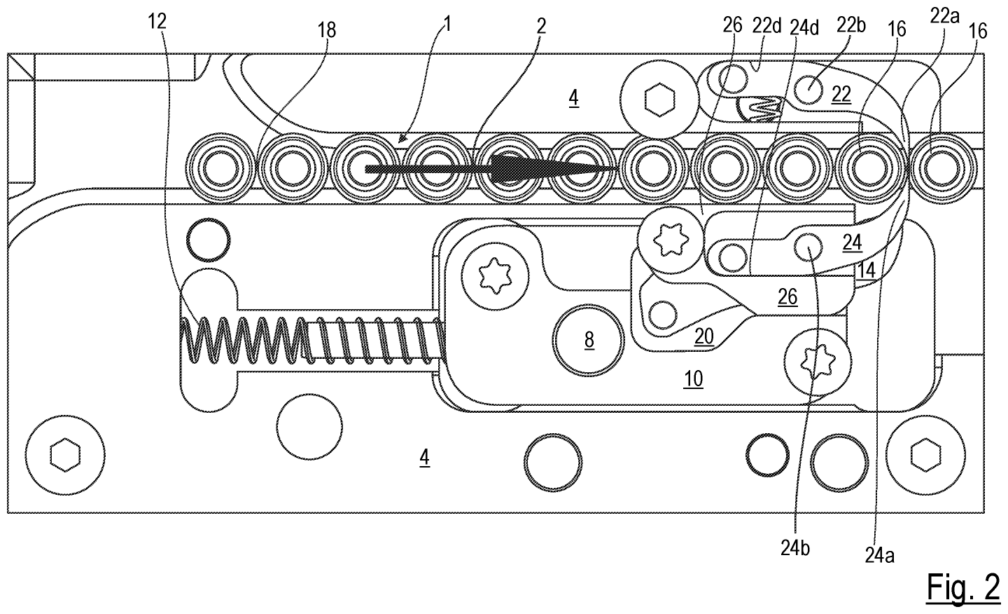

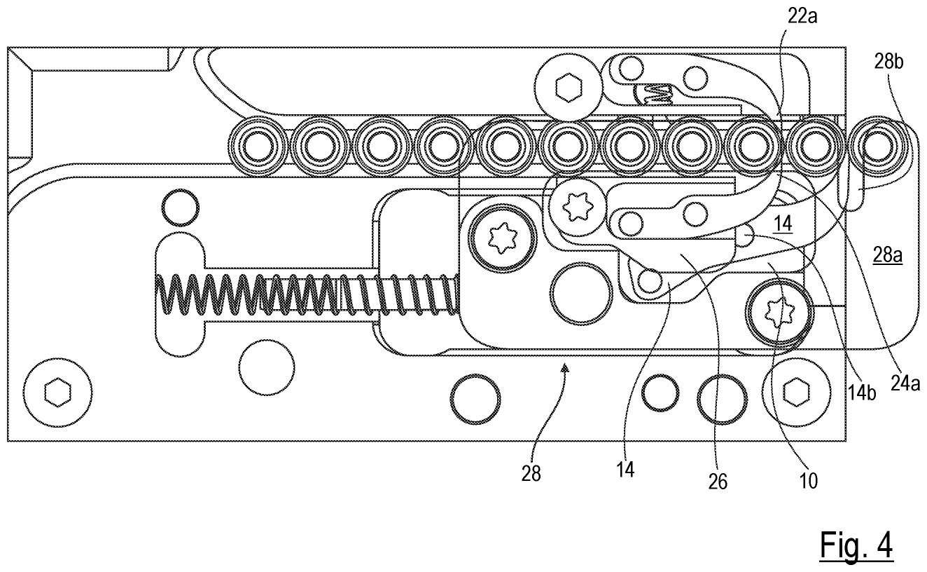

FIG. 2 shows the transport unit from FIG. 1 in a lateral view from the outside, wherein the lid 6 and a separation plate (shown in FIG. 4) have been omitted. In this representation, the advancing direction 2 is from left to right. It can be seen that the pivot 8 is inserted into a transport slider 10 inside the base body 4 and attached there. The transport slider 10 is tensioned by the pivot 8 against the force of a main spring 12 against the advancing direction 2 to the position shown in FIG. 2, whereupon the main spring 12 moves the transport slider 10 in the advancing direction 2. A transport pawl 14, whose transport nose (also shown in FIG. 4) is moved in between two wire ferrules 16 of the belt strip 18, is driven along via a pivot bearing (shown in FIG. 4). The pivot bearing of the transport pawl 14 is arranged in an indentation or recess 20 of the transport slider 10.

In a manner known in principle from the prior art, a first holding pawl 22 is mounted in the base body 4 via a pivot bearing 22b. A first holding nose 22a is inserted from above between the wire ferrules 16.

According to the disclosure, a second holding pawl 24 is provided via a pivot bearing 24b. A second holding nose 24a plunges in from below between the wire ferrules 16. In the configuration examples shown, the two holding pawls 22, 24 are of identical design and are arranged symmetrically with respect to the ferrule channel 1 or the advancing direction 2. During operation of the transport unit according to the disclosure, the two holding pawls 22, 24 pivot in a largely uniform manner. According to the disclosure, however, it is also possible that one of the two holding pawls 22, 24 does not pivot in, so that the holding function is only realized by the other holding pawl 22, 24.

In the pivoted-in position of the two holding pawls 22, 24 shown in FIG. 2, they rest with a respective extension against a stop 22d, 24d fixed to the base body for limiting the pivot movement in the insertion direction. The extensions are formed with respect to the respective pivot bearing 22b, 24b on a side opposite the respective holding nose 22a, 24a (on the left in FIG. 2) of the holding pawl 22, 24. The stop 22d for the first holding pawl 22 is formed on the base body 4, while the stop 24d for the second holding pawl 24 is formed in a recess of a bearing portion 26.

In contrast to the pivot bearing 22b of the first holding pawl 22, the pivot bearing 24b of the second holding pawl 24 is also arranged in the recess of the bearing portion 26. The bearing portion 26 is attached to the lid 6, which is attached to the base body 4 as described above.

FIG. 2 shows the two holding noses 22a, 24a and the covered transport nose in a maximally pulled-back position and the transport slider 10 in a maximally retracted position against the advancing direction 2, in which the main spring 12 is maximally tensioned.

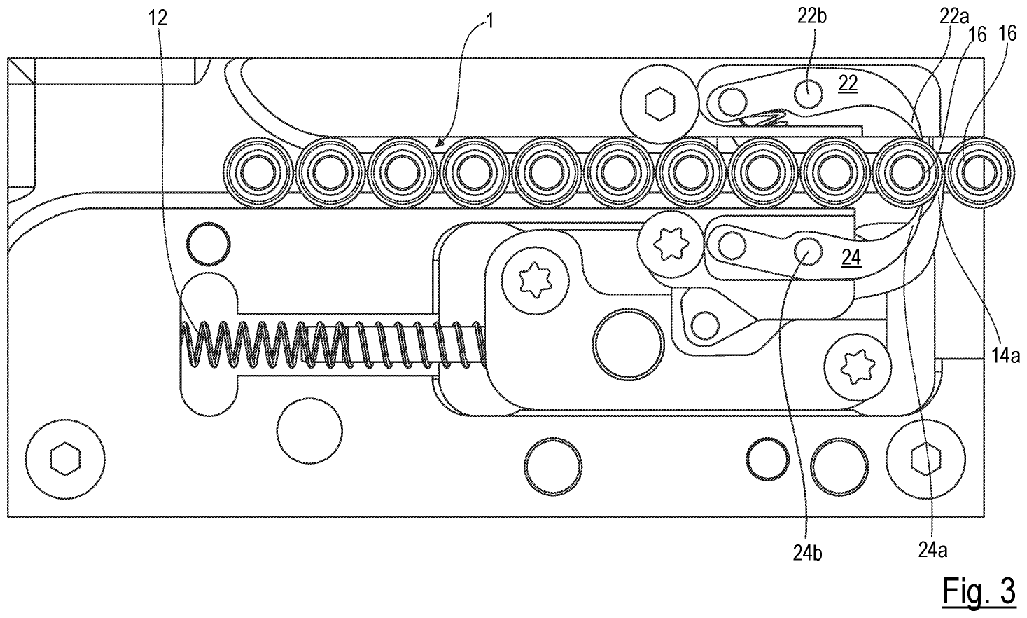

According to FIG. 3, starting from the position shown in FIG. 2, the transport nose 14a has now been moved in the advancing direction via the main spring 12, so that the wire ferrule 16 has already been partially pushed out of the ferrule channel 1. The subsequent wire ferrule 16 has pushed the two holding noses 22a, 24a out of the ferrule channel 1. For this purpose, the two holding pawls 22, 24 are pivoted around their pivot bearing 22b, 24b.

FIG. 4 shows a side view of the transport unit as shown in FIGS. 2 and 3. The end of the advancing movement is shown at which the two holding noses 22a, 24a have swung back into the ferrule channel 1 in order to prevent the belt strip 18 from moving backward when the transport nose 14 is now retracted by the transport slider 10.

FIG. 4 also shows the pivot bearing 14b of the transport pawl 14, since this has now been moved out of the cover in the advancing direction by the bearing portion 26.

A separation plate 28 (omitted in the preceding Figures) is attached to the transport slider 10 and oscillates with the transport slider 10. The separation plate 28 is shown translucent in FIG. 4. It has an extension 28a directed in the advancing direction, which was moved out in the advancing direction with the concerned wire ferrule 16 in the turning position shown in FIG. 4. A front side of a respective affected wire ferrule 16 can be brought into contact with the extension 28a transversely to the advancing direction when the wire ferrule 16 is separated. The separation plate 28 serves to keep the wire ferrule 16 at one height level.

A slit-shaped passage recess 28b is formed between the extension 28a and a main portion of the separation plate 28, into which a cutting knife is inserted for separating the concerned wire ferrule 16 from the belt strip 18.

Due to the subsequent retraction of the transport slider 10 and the spring-loaded transport pawl 14 mounted on it, the transport nose 14a slides over the foremost wire ferrule 16 of the belt strip 18 and transports the next wire ferrule 16, regardless of its cross-section, during a subsequent forward stroke to the separating edge of the transport unit, where the wire ferrule 16 can then be cut off separately by a cutting knife.

During retraction, the belt strip 18 is held by the two spring-loaded holding pawls 22, 24, which engage with a collar of the wire ferrule 16.

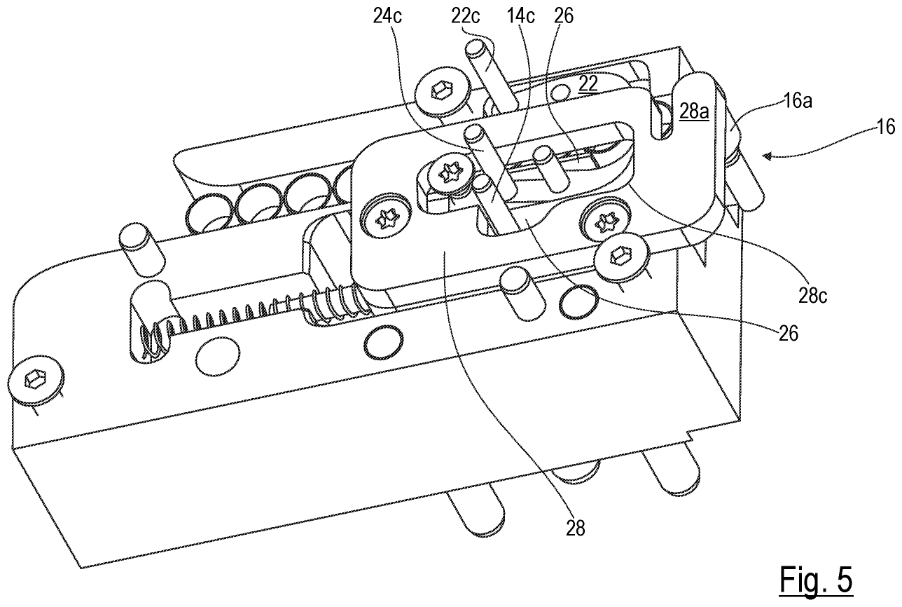

FIG. 5 shows a perspective view of the transport unit from the previous Figures, wherein only the lid 6 is omitted. The separation plate 28 is not shown translucent. The position corresponds approximately to that of FIG. 4.

All three pawls 14, 22, 24 have an extension which is opposite the nose 14a, 22a, 24a with respect to the pivot bearing 14b, 22b, 24b. A pin 14c, 22c, 24c arranged transversely to the advancing direction is attached to each extension and extends outward through an outer surface of the lid 6.

The separation plate 28 has a central passage recess 28c, through which the pin 14c of the transport pawl (not shown in FIG. 5) and the pin 24c of the second holding pawl 24 extend. Furthermore, during assembly of the lid 6, the bearing portion 26 of the separation plate 28, in which the second holding pawl 24 is mounted, passes through the central passage recess 28c of the separation plate 28.

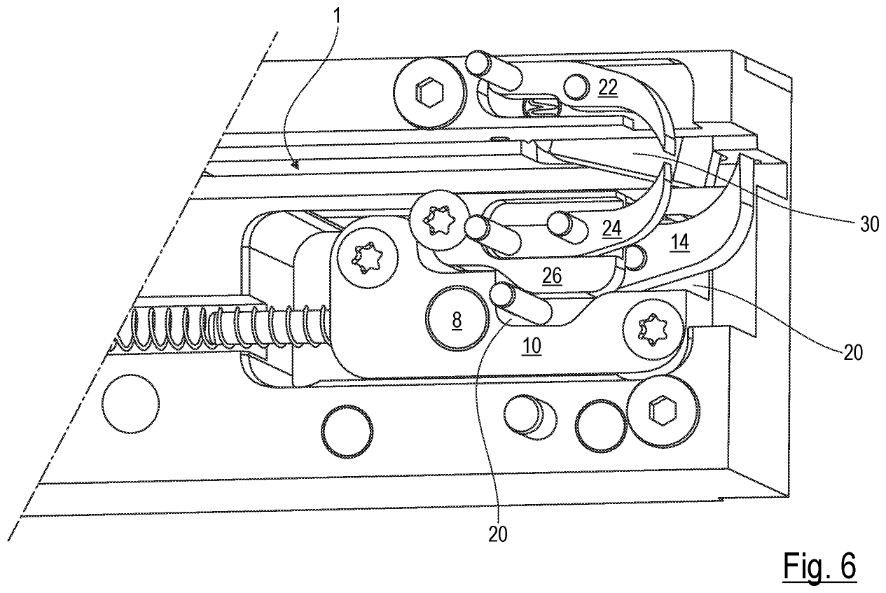

FIG. 6 shows a perspective view of the transport unit from the front, again omitting the lid 6 and the separation plate 28. In this perspective view and due to the omission of the wire ferrule 16, the stepping of the ferrule channel 1 can be seen, whereby it is adapted to the shape of the wire ferrules 16. It can also be seen that a spring-loaded flap 30 is provided at one foot of the sleeve channel 1 to prevent the last wire ferrule 16 of the belt strip 18 from jamming in the ferrule channel 1.

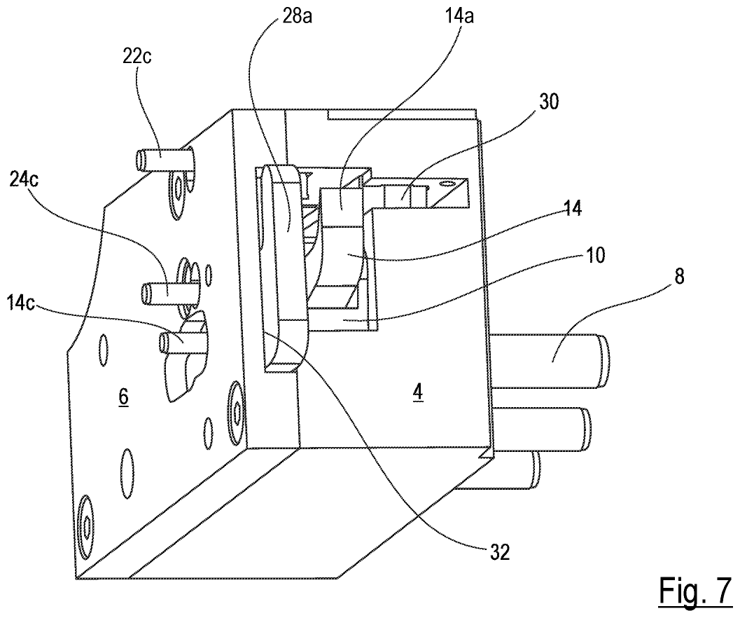

FIG. 7 shows a perspective view of the transport unit including the lid 6. The lid 6 has an indentation 32 on its inside, which serves as a guide for the separation plate 28.

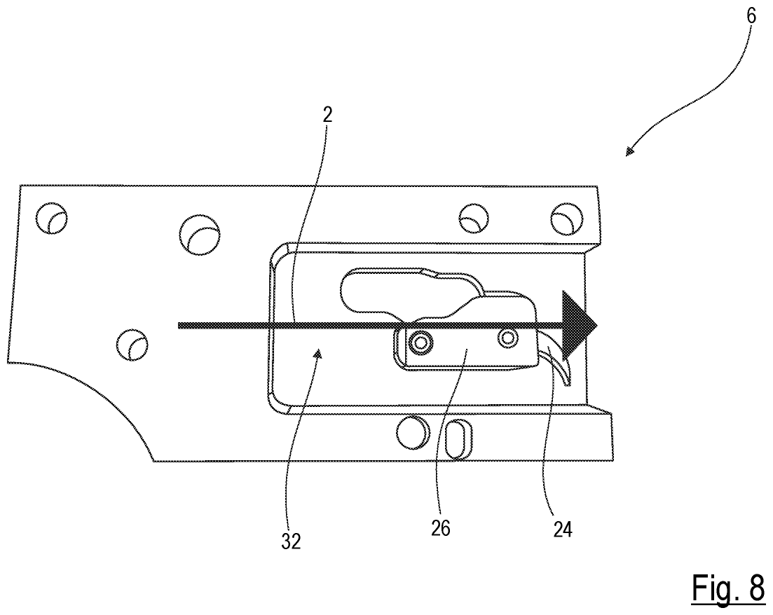

FIG. 8 shows the lid 6 from FIG. 1 in a view from the inside. The indentation 32 is shown. It has two edges parallel to the advancing direction, which serve as a guide for the separation plate 28 during its oscillating movement.

The bearing portion 26, in which the second holding pawl 24 is mounted, extends from the indentation 32 of the lid 6 toward the base body 4, i.e., inward in the preferred installation position of the transport unit.

In the configuration examples of the transport unit according to the disclosure shown in the Figures, the following sequence of components is obtained transversely to the advancing direction 2 or transversely to the ferrule channel 1 from the outside to the inside: the outer end portions of the pawls 14c, 22c, 24c of the pawls 14, 22, 24 at the very outside, then the outer surface of the lid 6, then the indentation 32 of the lid 6 with the separation plate 28, then the bearing portion 26 of the lid 6 and the two holding pawls 22, 24, then the transport pawl 14, then the slim or narrow part of the ferrule channel 1, and finally the outer end portion of the pivot 8 at the very inside. In this view, the recess 20 of the transport slider 10 extends over the two holding pawls 22, 24 and over the transport pawl 14.

### LIST OF REFERENCE SYSBOLS

1 ferrule channel
2 advancing direction
4 base body
6 lid
8 pivot
10 transport slider
12 main spring
14 transport pawl
14a transport nose
14b pivot bearing of the transport pawl
14c pin
16 wire ferrule
18 belt strip
20 recess of the transport slider
22 first holding pawl
22a first holding nose
22b first pivot bearing
22c pin
22d first stop
24 second holding pawl
24a second holding nose
24b second pivot bearing
24c pin
24d second stop
26 bearing portion of the lid
28 separation plate
28a extension
28b slit-like passage recess
28c central passage recess
30 spring-loaded flap
32 indentation of the lid

What is claimed is:

1. A transport unit comprises a base body, in which a ferrule channel is formed through which a belt strip with wire ferrules is movable stepwise in an advancing direction via a transport nose, wherein the transport nose is formed on a transport pawl, which is pivotably articulated to a transport slider which can be driven in an oscillatingly guided movable manner, wherein the transport nose is insertable between two respective wire ferrules, and wherein the belt strip can be supported in a retracting direction reverse to the advancing direction via a first holding nose, wherein the first holding nose is formed on a first holding pawl, a first pivot bearing of which is fixed to the base body, wherein the first holding nose is insertable between the two respective wire ferrules, wherein the belt strip can be supported in the retracting direction via a second holding nose, wherein the second holding nose is formed on a second holding pawl, a second pivot bearing of which is fixed to the base body, wherein the second holding nose is insertable between the two respective wire ferrules.

2. The transport unit according to claim 1, wherein the first holding pawl and the second holding pawl are located opposite each other with respect to the ferrule channel.

3. The transport unit according to claim 1, wherein a stop fixed to the base body for limiting pivot movement in insertion direction is provided for each holding pawl.

4. The transport unit according to claim 1, wherein the first holding pawl and the second holding pawl are configured identically or with a different thickness.

5. The transport unit according to claim 1, wherein the second pivot bearing is arranged in a bearing portion of a lid of the transport unit, which extends along or parallel to the ferrule channel.

6. The transport unit according to claim 5, wherein the first holding pawl and the second holding pawl are arranged between the transport pawl and an outer surface of the lid.

7. The transport unit according to claim 5, wherein at least one of the transport pawl (14), the first holding pawl (22) and the second holding pawl (24) has a respective extension which is opposite the (14a, 22a, 24a) with respect to the respective pivot bearing (14b, 22b, 24b), wherein a respective pin (14c, 22c, 24c) is attached to the respective extension and extends outward through an outer surface of the lid.

8. The transport unit according to claim 7, wherein the pivot bearing of the transport pawl is arranged on the transport slider, wherein a recess for the extension of the transport pawl is formed in the transport slider.

9. The transport unit according to claim 5, wherein the bearing portion of the lid is arranged substantially in a recess of the transport slider.

10. The transport unit according to claim 5, wherein a separation plate is formed or attached to the transport slider.

11. The transport unit according to claim 10, wherein the separation plate has a separation plate extension directed in the advancing direction, against which a front side of a respective wire ferrule (16) can be brought into contact transversely to the advancing direction.

12. The transport unit according to claim 11, wherein a slit-like passage recess is arranged between the separation plate extension and a main portion of the separation plate, into which a cutting knife is insertable for cutting off a wire ferrule (16) from the belt strip.

13. The transport unit according to claim 12, wherein the main portion of the separation plate is arranged and/or guided at least sectionally in an indentation on an inner side of the lid.

14. The transport unit according to claim 13, wherein the indentation of the lid comprises the bearing portion of the lid, wherein the bearing portion extends through a passage recess of the separation plate.

15. The transport unit according to claim 1, with a spring-loaded flap on a foot of the ferrule channel.
